(19) United States
(12) Patent Application Publication
(10) Pub. No.: US 2021/0049484 A1
(43) Pub. Date: Feb. 18, 2021

(54) SYSTEM AND METHOD FOR PROVIDING SUPERVISION OF PERSONS USING TAGS WITH VISUAL IDENTIFICATION CODES USING ARTIFICIAL INTELLIGENCE METHODS TO PREVENT FRAUD.

(71) Applicant: Luis Martins Job, Florianopolis (BR)

(72) Inventor: Luis Martins Job, Florianopolis (BR)

(21) Appl. No.: 16/983,223

(22) Filed: Aug. 3, 2020

Related U.S. Application Data
(60) Provisional application No. 62/886,110, filed on Aug. 13, 2019.

(51) Int. Cl. G06N 5/04; G06N 20/00

(52) U.S. Cl. CPC G06N 5/04; G06N 20/00

(57) ABSTRACT

Embodiments provide methods and systems to acknowledge a person's presence when inspecting predetermined locations, objects or both 200. The person confirms his/her presence at one or more locations, taking a photo with the user device 407 from the tag with a visual identification code 413 that has been fixed at predetermined locations or on objects being visited. The tags with identification codes are easily and inherently copyable, counterfeiting the person's presence at a predetermined location, object or both. A trained learning machine model 403 will classify photos from the user device as valid or invalid. Only valid photos will be used to confirm the person's presence.

### CROSS-REFERENCE TO RELATED APPLICATIONS

The present application claims the benefit of provisional patent application Ser. No. priority from 62/886,110, filed 2019 Aug. 13 by the present inventor, which is incorporated by reference in its entirety.

### FIELD OF THE INVENTION

The present invention relates to location-based data processing. More particularly, the present invention relates to the monitoring and tracking of users or employees of an organization or a company as the users or employees move in a route or need to inspect some specific location.

### BACKGROUND OF THE INVENTION

There are a variety of known means to acknowledge the presence at predetermined locations of an employee or person who is assigned the task of investigating these locations, for example: security patrol officers move from checkpoint to checkpoint on a tour defined by a commander. Prison guards move through areas of a prison while making “rounds” defined by a supervisor. Police officers move through areas or “beats” of their city as defined by a commander. Delivery trucks move from store to store making deliveries on a route defined by a supervisor or a manager. Military missions move from location to location in the pursuit of accomplishing a mission or a journey defined by a commanding officer. Employees move throughout a company to inspect fire extinguishers or other specific elements as defined by a company manager.

Normally tags with some kind of identification code are fixed onto the specified locations and those responsible for the tour or inspection carry some kind of electronic device which reads the code from the tag confirming his/her location. Visual identification codes, as barcodes, QR codes or others, due to their simplicity, low cost implementation and facility in the reading process, have been widely used to obtain identification from the tags.

The visual identification code, however, is easily and inherently copyable. It is very easy to take a photo of the tag with a visual identification code and use the photo to scan, counterfeiting a presence at a predetermined location.

For these reasons, although the visual identification codes, as the barcodes, have been prevalent for tracking for a while, they have been replaced by other technologies, such as electronic chips with serial numbers, RFID devices, GPS trackers and others.

U.S. Pat. No. 5,120,942A to Holland, et al. discloses a tour tracking monitor system. The tour monitor includes a barcode reader, an alphanumeric display and an alphanumeric keyboard. The tour is organized into zones, each one including a set of checkpoints, wherein each checkpoint is labeled by a barcode. The system in Holland relies on barcode tag readings.

U.S. Pat. No. 4,688,026A to Scribner, et al. discloses a tracking monitor system. Here barcode tags are replaced by tags capable of wirelessly transmitting unique codes when energized by radio frequency (RF) to identify a variety of different locations and objects.

U.S. Pat. No. 7,363,196B2 to Markwitz, et al. discloses a guard tour tracking system. Here, electronic chips with serial numbers are used as identification codes. In this disclosure, a specific identification code reader is present.

U.S. Pat. No. 7,778,802B2 to Markwitz, et al. discloses a guard tour tracking system. Here, barcodes, radio frequency (RF) tags, chips with serial numbers, GPS technology are used as means of location confirmation. In this disclosure, smartphones with specific built-in reading capabilities are used as readers of those identification code technologies.

I have found that the prior art has relied on the replacement of tags with visual identification codes, as barcodes, for other technologies. These disclosures reveal the use of proprietary readers or smartphones with specific built-in reader features. None of the prior art reveal any system or method to prevent counterfeiting by cloning tags with visual identification codes.

There is a need in the prior art for a system and method for detecting counterfeiting by employees using tags with visual identification codes, read by low cost standard smartphones with cameras while maintaining the simplicity and low cost of the system.

### SUMMARY OF THE EMBODIMENTS

The present invention relates to a system and method to increase the reliability of the process of acknowledging, at predetermined locations, the presence of people who are assigned the task of investigating these locations. Presence is verified by taking a photo from a tag with a visual identification code, fixed in a predetermined location, by classifying the photo of the tag with visual identification code as either valid or not. The photo will be marked invalid when it is not obtained directly from the tag but from a representation of the tag with visual identification code. Tag visual representation can be, but is not restricted to, visualizations on smartphone screens, on tablet screens or on sheets of paper. The method according to one embodiment may include the following steps: a photo from the tag with a visual identification code is obtained; the photo is identified as valid if it was obtained directly from the tag with the visual identification code; otherwise it is identified as invalid (cloned) if it is a photo of the representation of the tag with visual identification code.

Validation/identification is done by a trained machine learning model.

Some embodiments of the system may include a network, a server connected to the network, a trained machine learning model, a computer program, one or more user devices with cameras and one or more tags with visual identification codes.

### BRIEF DESCRIPTION OF THE DRAWINGS

FIG. 1 shows examples of tags with visual identification codes, according to different embodiments.

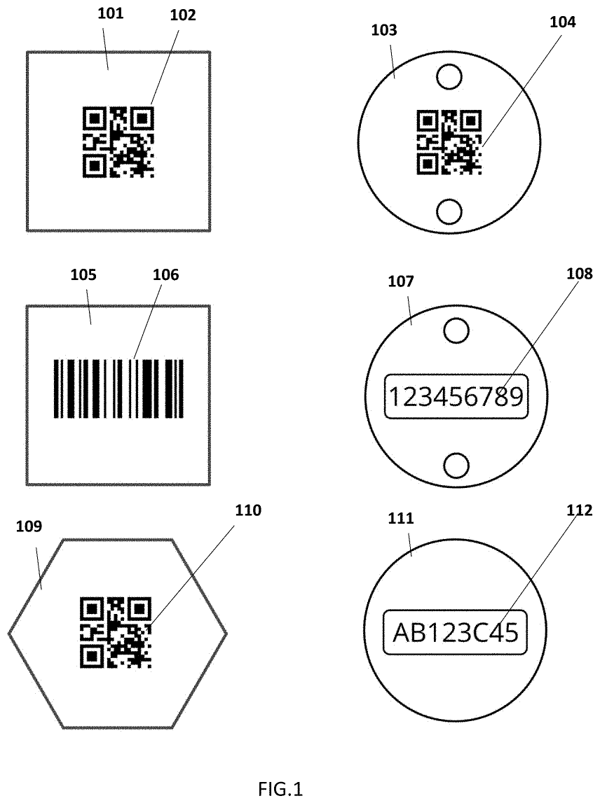

FIG. 2 shows some tags with visual identification codes, fixed on some locations, according to different embodiments.

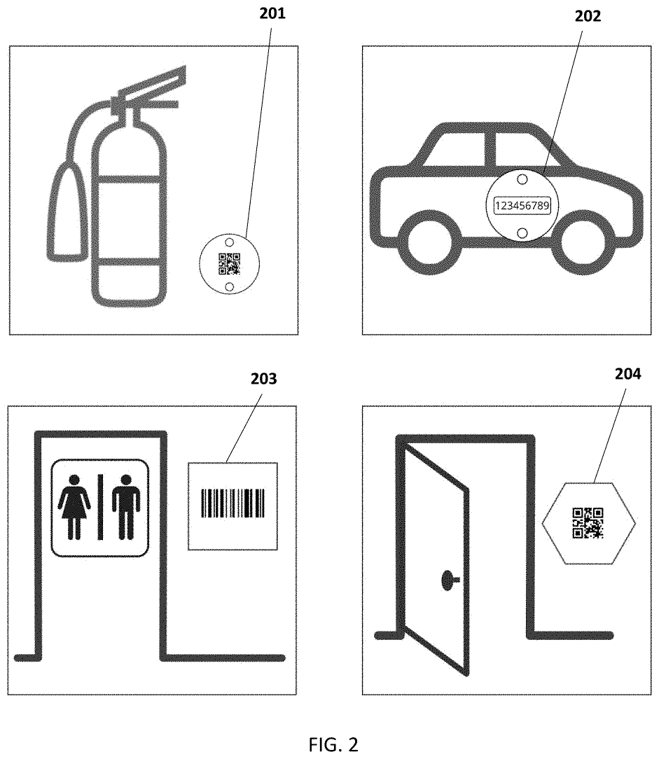

FIG. 3 shows some representations of tags with visualization codes, according to different embodiments.

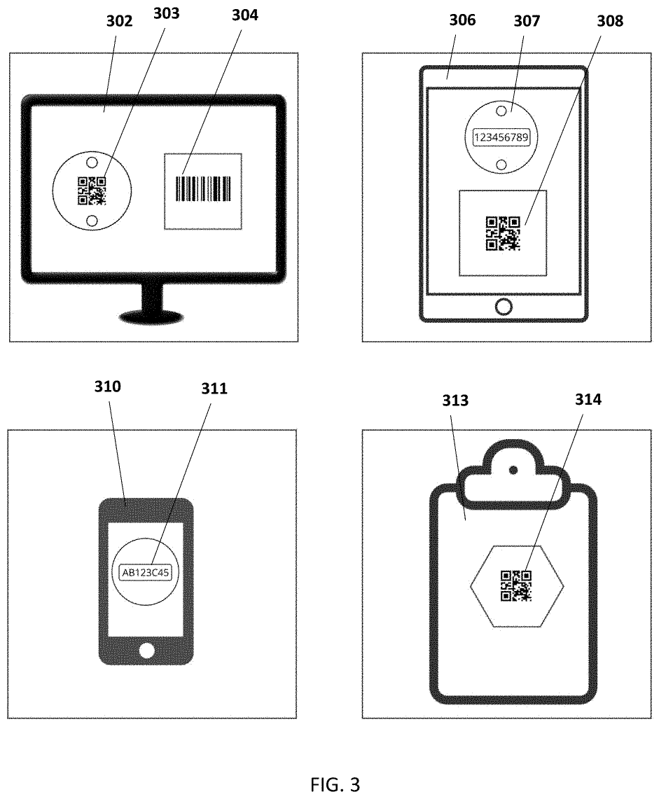

FIG. 4 shows a diagram of a system for supervising user movement, avoiding the counterfeiting of a user's proof of location, according to different embodiments.

FIG. 5 shows a diagram of a process acknowledging and validating/identifying users' activity, avoiding the counterfeiting of the validation process, according to different embodiments.

FIG. 6 shows a flow chart illustrating a method for acknowledging and validating a user's activity, avoiding the counterfeiting of the validation process, according to different embodiments.

FIG. 7 shows a flow chart illustrating a method for training a learning machine model, according to different embodiments.

### DETAILED DESCRIPTION

The present invention may be further understood with reference to the following description of embodiments to appended drawings. The present invention generally relates to a system and method for increasing the reliability of tracking users using devices that obtain photos from located tags with visual identification codes 100 to prove users' locations 200. The system distinguishes counterfeit photos 300 from genuine photos. Specifically, the present invention is related to a system and method for validating a tag with a visual identification code, analyzing the tag photo by means of a learning machine model.

The tag is a means to position the visual identification code onto walls or objects. A visual identification code is a means to assign a unique label to an object. Tags with visual identification codes are fixed in/on predefined locations or objects that are supposed to be inspected by the user or that make part of an inspection route assigned to the user. This process assigns a unique identification to each location and/or object.

In some embodiments, the visual identification code can be a barcode 106, a QR code 102, 104 and 110, a numeric code 108, an alphanumeric code 112 or any other visual identification code.

In some embodiments, the tag can be any piece of material where the identification code is engraved, printed 101, 103, 105, 107, 109 and 111 or fixed by any other method.

In some embodiments, the tag with a visual identification code is fixed in/on predefined locations or objects that can be, for example, close to a fire extinguisher 201, onto a vehicle 202, close to a bathroom door 203, onto a building main entrance door 204 or any other location or object that needs to be visited for someone for some kind of inspection or that are part of a predefined route or tour.

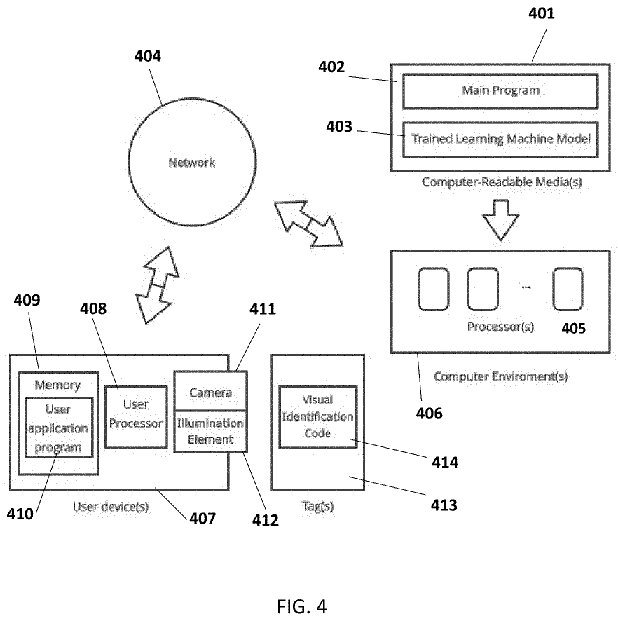

FIG. 4 shows a system 400 according to one embodiment for supervising, tracking or monitoring users, guards, inspectors or any kind of people assigned to some inspection or security route. This embodiment identifies when a counterfeit, cloned or a representation of the tag with a visual identification code is read. This system embodiment includes, but is not limited to, one or more user devices 407, a trained learning machine model 403, a main program 402, a computer-readable media 401, a network 404, one or more processors 405 and one or more tags with identification codes 413. In this embodiment, the user device 407 can include, but is not limited to, a camera, an illumination element, a memory, a user application program and a user processor.

In some embodiments, the user device 407 can include, but is not limited to, smartphones, tablets or a wearable device (e.g., a smartwatch).

In some embodiments, a computer environment 406 includes, but is not limited to, one or more processors 405 and at least one computer-readable media 401.

In some embodiments, the computer-readable media 401 can include the main program 402 and the trained learning machine model 403.

In some embodiments, the trained learning machine model can be based on at least one of the following models: convolutional neural network model, feed-forward neural network model, recurrent neural network model, long-short term memory network model, gated recurrent unit model, boltzmann machine model, deep belief network model, auto encoder model, generative adversarial network model, support vector model, linear regression model, logistic regression model, naive bayes model, linear discriminant analysis model and nearest neighbor algorithm model.

In some embodiments, the user application program 410 is a mobile application executed on a smartphone or tablet computer. In another embodiment, the user application program 410 is a web application executed through an Internet browser.

In some embodiments, the computer program code for carrying out the operations of aspects of the present disclosure, as the main program 402, the user application program 410 and the trained learning machine model 403 may be written in any combination of one or more programming languages, including an object oriented programming language such as Java, Scala, Smalltalk, Eiffel, JADE, Emerald, Objective C, C++, C#, VB.NET, Python or the like; conventional procedural programming languages, such as the “C” programming language, Visual Basic, Fortran 2003, Perl, COBOL 2002, PHP, ABAP; dynamic programming languages such as Python, PHP, HTML, AJAX, Ruby and Groovy or other programming languages. The program code may execute entirely on the user device 407, partly on the user device 407, partly on the user device and partly on the processor 405 or entirely on one or more processors 405 or on any available computer resource.

In some embodiments, the one or more processors 405 may be connected to the one or more user devices 407 and/or through any type of network 404, including a local area network (“LAN”) or a wide area network (“WAN”) or a cellular network providing a data connection to the Internet.

In one embodiment, the network 404 is a cellular network providing a data connection to the Internet.

In another embodiment, the network 404 is a local Wi-Fi network providing a data connection to the Internet. In another embodiment, the network 404 is a local network.

In another embodiment, the network 404 is a Bluetooth wireless network.

In other embodiments, other known wireless and wired networks may be employed.

In some embodiments, the computer-readable media 401 may be a computer readable signal medium or a computer readable storage medium. For example, the computer readable storage medium may be, but not limited to, an electronic, magnetic, optical, electromagnetic or semiconductor system, apparatus or device, or any suitable combination of the foregoing. More specific examples of the computer readable storage medium would include, but are not limited to: a hard disk, a random access memory (“RAM”), a read-only memory (“ROM”), an erasable programmable read-only memory (“EPROM” or Flash memory), an optical storage device, a magnetic storage device or any suitable combination of the foregoing. Thus, a computer readable storage medium may be any tangible medium that can contain or store a program for use by or in connection with an instruction execution system, apparatus or device.

In some embodiments, the computer environment 406 can contain one or more processors 405 connected to the network 404. In one embodiment one or more computer environments 406 can be a cloud computing environment or offered as a service such as a Software as a Service (“SaaS”). In another embodiment, the one or more computer environments 406 can be a local group of one or more physical computer servers.

In some embodiments, the user can be, but not restricted to, a security officer on a tour, a soldier on a mission, a service technician, cleaning or maintenance personnel at a jobsite, a delivery man on a delivery route, a prison guard making rounds or any employee or person assigned the task of investigating locations, objects or both.

In some embodiments, the user associated with the user device 407 reads tags with visual identification codes 413 during his/her tour or inspection. In these embodiments, readings with the user device 407 means that the user, using the user device 407, took a photo from the tag with a visual identification code 413.

In some embodiments, the main program 402 is a computer code executed by one or more processors 405. In these embodiments, the main program 402 is a set of machine code instructions that receives and examines data from the user device 407 and exchanges data with the trained learning machine model 403.

In some embodiments, the main program 402 exchanges data from the user device 407 with the trained learning machine model 403 that classifies the photo from the user device as a valid photo or an invalid photo.

In some embodiments, the trained learning machine model 403 classifies the photo as an invalid photo when the photo taken by the user device 407 is from a representation of the tag with the visual identification code. In these embodiments, the representation of the tag with the visual identification code is a visualization of the tag with the visual identification code by a media. In these embodiments, the media can be, but is not restricted to, a computer screen 302, a tablet screen 306, a sheet of paper 313, a smartphone 310 or any other form of displaying an image. In these embodiments, the photo is classified as a valid photo if the photo taken by the user device is from the tag with the visual identification code.

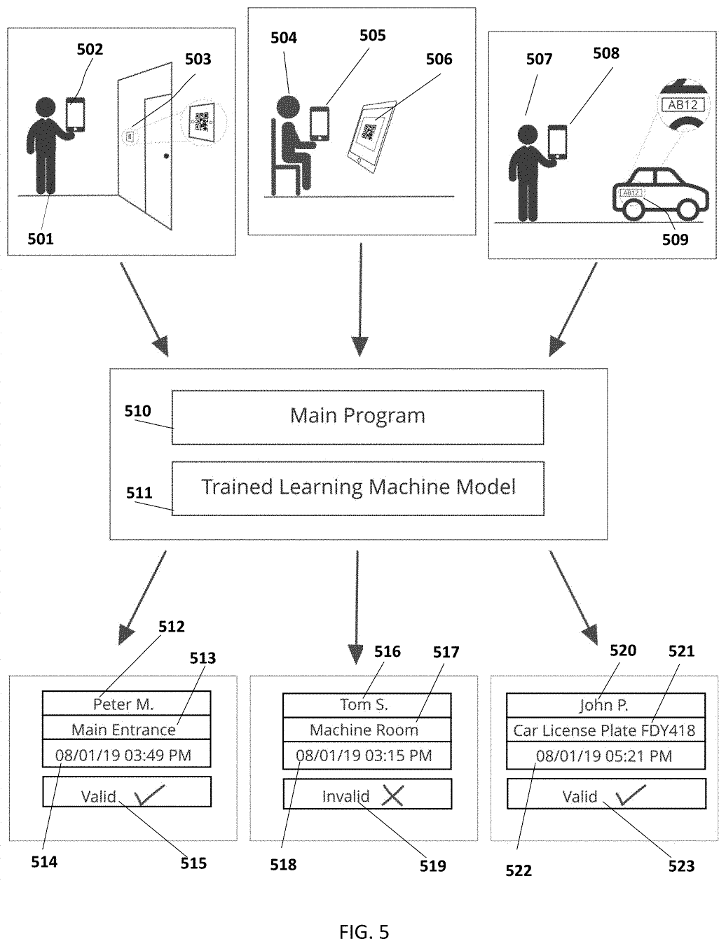

FIG. 5 presents a diagram illustrating some embodiments for the process of supervising the user movement that avoids counterfeiting user location confirmation.

In one embodiment, a user 501, using a user device 502, is taking a photo of a tag with a visual identification code 503 fixed onto the wall. In this example, a main program 510 obtains a photo, a timestamp, a location name and a user identification name. A trained learning machine model 511 classifies the photo. The main program 510 evaluates the user's movement. In this particular example, information that Peter M 512 was at Main Entrance 513 on Aug. 1, 2019 at 3:49 PM 514 was obtained and classified as valid 515.

In another embodiment a user 504, using a user device 505, takes a photo of a representation of a tag with a visual identification code 506 on the tablet screen. In this example, the main program 510 obtains the photo, the time stamp, the location name, and the user identification name. The trained learning machine 511 classifies the photo. Then main program 510 assesses the user as Tom S.516 counterfeiting his location that was to be in Machine Room 517, on Aug. 1, 2019 3:15 PM 518. Confirming location as invalid 519.

In another embodiment a user 507, using a user device 508, takes a photo of a tag with a visual identification code 509 fixed onto a vehicle. In this example the main program 510 obtains the photo, the timestamp, the location name and the user identification name. The trained learning machine model 511 classifies the photo. The main program identifies the user as John P 520, at vehicle license FDY418 521, on Aug. 1, 2019 at 5:21 PM 522. Location is confirmed valid 523.

In some embodiments, the location name can be a name, a numeric code, an alphanumeric code or any piece of information that identifies the location.

In some embodiments, the user identification name can be a name, a numeric code, an alphanumeric code or any piece of information that identifies the user.

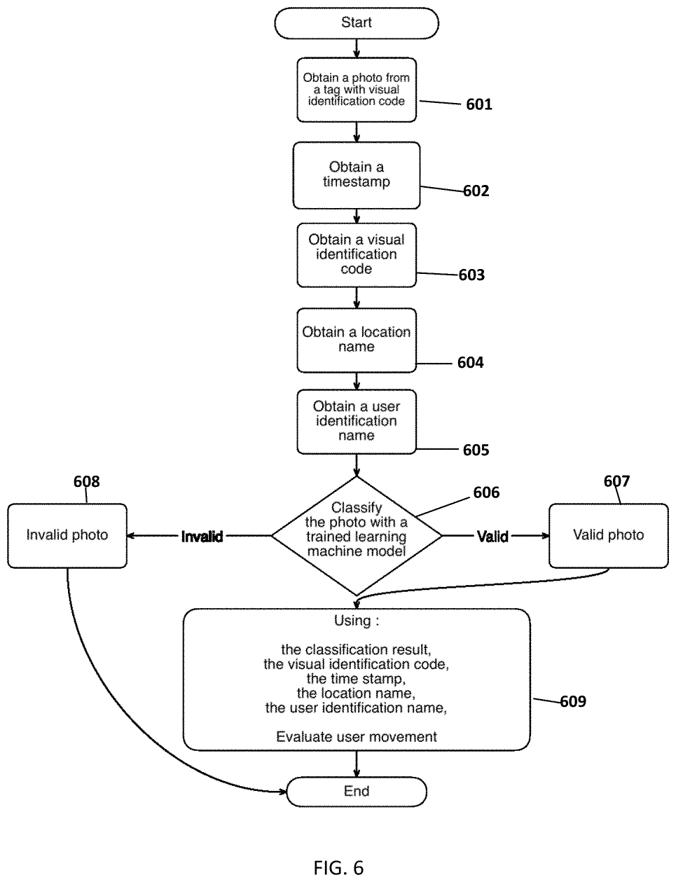

FIG. 6 presents a flowchart illustrating one embodiment for the method of supervising the user movement that avoids counterfeiting user location. In this flowchart, the main program obtains, from the user device, a photo from the tag with a visual identification code 601. The photo is obtained by the user device, when the user goes to some location. His/her location is, with the use of the user device, confirmed by reading—taking a photo of—the tag with a visual identification code that is fixed in that specific location. From the photo, the main program obtains a timestamp 602 that is composed of the time and date when the user device reads the photo. The main program obtains, from the tag with a visual identification code, a location name 604 and a visual identification code 603. The main program obtains from the user or the user device, the user identification name 605. The trained learning machine model classifies the photo as a valid photo or an invalid photo 606. The main program uses the photo classification by the trained learning machine, the visual identification code, the timestamp, the location name and the user identification name to evaluate the user movement 609.

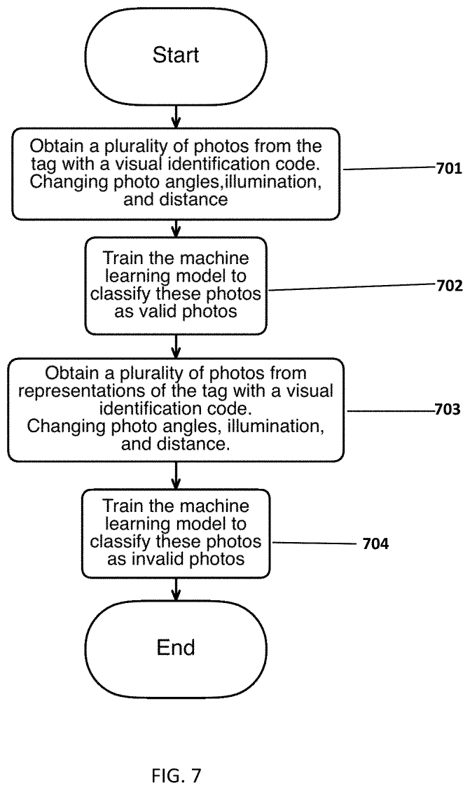

FIG. 7 presents a flowchart illustrating one embodiment for the method of training a learning machine to classify a photo as a valid photo or an invalid photo. A plurality of photos of the tag with an identification code is used to train a learning machine model to recognize those photos as valid photos. The difference from each photo belonging to that group is obtained by changing some or all photo parameters. The photo parameters are photo angle, photo distance, photo illumination or any other parameter that may change a photo result 701, 702. A plurality of photos from the representation of the tag with identification code is used to train a learning machine model to recognize those photos as invalid photos. The difference from each photo belonging to the group is obtained by changing some or all the photo parameters. The photo parameters are photo angle, photo distance, photo illumination or any other parameter that may change the photo result 703, 704.

It will be appreciated by those skilled in the art that modifications can be made to the embodiments disclosed and remain within the inventive concept. Therefore, this invention is not limited to the specific embodiments disclosed but is intended to cover changes within the scope and spirit of the claims.

The invention claimed is:

1. A method that avoids counterfeiting tags with visual identification codes used as location confirmation when supervising people's movements, comprising:
obtaining, from a user device, at least one photo of a tag with a visual identification code;
obtaining, from the photo of the tag with the visual identification code, a timestamp;
obtaining, from the photo of the tag with the visual identification code, a visual identification code;
obtaining, from the tag with the visual identification code, a location name;
obtaining, from the user or a user device, a user identification name;
determining, with a trained machine learning model, the validity of at least one of the photos of the tag with visual identification code, wherein the steps of determining the validity comprises:
using the trained machine learning model that has been trained on two classes of photos, including a plurality of photos of the tag with the visual identification code labeled as valid photos, and a plurality of photos of the visual representation of the tag with the visual identification code labeled as invalid photos; and
classifying at least one of the photos of the tag with the visual identification code photo as the valid photo or the invalid photo; and
evaluating, the user movement, wherein the steps of evaluating comprises:
using at least one result from the trained leaning machine classification;
using at least one of the visual identification codes;
using at least one of the timestamps;
using at least one of the location names; and
using at least one of the user identification names.

2. The method according to claim 1, wherein the tag with the visual identification code is any piece of material in which the identification code is printed, engraved or attached.

3. The method as claimed in claim 1, wherein the visual identification code comprises one of:
barcode code;
qr code;
numeric code;
alphanumeric code; or
any other visual identification code.

4. The method as claimed in claim 1, wherein the representation of the tag with the visual identification code comprises one of:
displaying the visual representation of the tag with the visual identification code on a computer screen;
displaying the visual representation of the tag with the visual identification code on a mobile phone screen;
displaying the visual representation of the tag with the visual identification code on a tablet screen; and
displaying the visual representation of the tag with the visual identification code on a sheet of paper.

5. The method according to claim 1, wherein at least one photo of the tag with the visual identification code is executed with a smartphone.

6. The method as claimed in claim 1, wherein the machine learning model comprise one of:
convolutional neural network model;
feed-forward neural network model;
recurrent neural network model;
long-short term memory network model;
gated recurrent unit model;
boltzmann machine model;
deep belief network model;
auto encoder model;
generative adversarial network model;
support vector model;
linear regression model;
logistic regression model;
naive bayes model;
linear discriminant analysis model; and
nearest neighbor algorithm model.

7. A system that avoids forfeiting tags with visual identification codes being used as location confirmation when supervising people's movements, comprising:
a network;
at least one user device;
at least one tag with a visual identification code;
at least one training learning model;
at least one processor connected to the network; and
at least one computer-readable media storing computer executable instructions that, when executable causes the one or more processors to perform acts comprising:
obtaining, from the user device, at least one photo of the tag with the visual identification code;
obtaining, from the photo of the tag with the visual identification code, a timestamp;
obtaining, from the photo of the tag with the visual identification code, a visual identification code;
obtaining, from the tag with the visual identification code, a location name;
obtaining, from the user or a user device, a user identification name;
determining, with the trained machine learning model, the validity of at least one of the photos of the tag with the visual identification code, wherein the steps of determining the validity comprises:
using the trained machine learning model that has been trained on two classes of photos, including a plurality of photos of the tag with the visual identification code labeled as valid photos and a plurality of photos of a visual representation of the tag with the visual identification code labeled as invalid photos; and
classifying, at least one of the photos of the tag with the visual identification code photo as the valid photo or the invalid photo; and
evaluating the user movement, wherein the steps of evaluating comprises:
using at least one result from the trained learning machine model classification;
using at least one of the visual identification codes;
using at least one of the timestamps;
using at least one of the location names; and
using at least one of the user identification names.

8. The system according to claim 7, wherein the tag with the visual identification code is any piece of material in which the identification code is printed, engraved or attached.

9. The system as claimed in claim 7, wherein the visual identification code comprises one of a:
barcode code;
two-dimensional barcode code;
qr code;
numerical code;
alphanumeric code, or
any other visual identification code.

10. The system as claimed in claim 7, wherein the representation of the tag with the visual identification code comprises one of:
displaying the visual representation of the tag with the visual identification code on a computer screen;
displaying the visual representation of the tag with the visual identification code on a mobile phone screen;
displaying the visual representation of the tag with the visual identification code on a tablet screen; and
displaying the visual representation of the tag with the visual identification code on a sheet of paper.

11. The system according to claim 7, wherein at least one photo of the tag with the visual identification code is executed with a smartphone.

12. The system as claimed in claim 7, wherein the machine learning model comprises one of:
convolutional neural network model;
feed-forward neural network model;
recurrent neural network model;
long-short term memory network model;
gated recurrent unit model;
boltzmann machine model;
deep belief network model;
auto encoder model;
generative adversarial network model;
support vector model;
linear regression model;
logistic regression model;
naive bayes model;
linear discriminant analysis model; and
nearest neighbor algorithm model.
